(19) United States
(12) Patent Application Publication
(10) Pub. No.: US 2006/0232375 A1
(43) Pub. Date: Oct. 19, 2006

(54) Device for using numerous articles, each article comprising at least one contactless data medium

(76) Inventors: Christophe Loussert, Aix-en-Provence (FR); Philippe Martin, Beaune (FR)

Correspondence Address: BACHMAN & LAPOINTE, P.C., 900 CHAPEL STREET, SUITE 1201, NEW HAVEN, CT, 06510, US

(21) Appl. No.: 10/538,555

(22) PCT Filed: Dec. 12, 2003
(86) PCT No.: PCT/FR03/50165

§ 371 Date: May 24, 2006

(30) Foreign Application Priority Data
Dec. 12, 2002 (FR) 02/15743

(51) Int. Cl. G05B 19/00; G05B 23/00

(52) U.S. Cl. 340/5.8; 340/10.42; 340/572.8

(57) ABSTRACT

A device which is used to identify articles comprises an RF-ID type contactless label, the articles being aligned on a medium. The device comprises an antenna. The invention is characterized in that the aforementioned antenna is disposed in a flexible head which can deform upon contact with the contour of at least some of the aligned articles, in order to form a contact zone with the contour of the articles which are in contact and a zone extending a handling support. The invention also relates to a system for identifying articles.

### BACKGROUND OF THE INVENTION

(1) Field of the Invention

The present invention relates to the field of electronic labels which allow a contactless reading of an item of data and which are read remotely by a query/read device emitting an electric or electromagnetic field. These more generally involve data media of the RFID type capable of taking various forms, such as labels, cards, stoppers, and without the present invention being limited to a particular form of the inventive medium.

(2) Prior Art

Currently, on the contactless data media market, there are “bar codes” which are printed on the articles to identify them and which are read by a manual or fixed optical device usually situated at the entrance of a store or a library for example.

Bar codes have the disadvantage of being read only one after the other, which represents a significant wastage of time when stock-taking is involved.

Thus, RFID labels are currently proposed which contain electronic circuits such as a memory capable of recording a n-bit binary code. One of the main advantages of RFID labels lies in the fact that they can be read simultaneously.

In booklending or videolending libraries, it is necessary to quickly and efficiently check off all the products that are available to the public and are present on the shelves on a given date. Furthermore, it is also desirable to have a device that can be used to quickly find a particular article. That is why systems for reading the data media present on the spine of each book, CD-ROM or DVD-ROM have been proposed for rapidly checking off all the available products or for finding a particular article.

The prior art already knows the American patent U.S. Pat. No. 6,232,870 which describes in particular a portable device for reading data media. The user places in front of each article the portable device furnished with a substantially longitudinal fixed arm whose end is provided with a means of reading or querying the data media, the device also comprising a display screen for displaying the identity and data relating to the article concerned.

This device requires the user to stop in front of each article to bring the reading or querying means to the immediate proximity of the data medium. This technique is therefore awkward and lengthy and so is not suitable for a complete check, or even a search, of all the articles present in the library at a precise moment.

Also proposed in American patent application Ser. No. 09755714 are two solutions for a device for reading/querying data media of the RFID type. The first solution consists of a portable device substantially identical to that described in American patent U.S. Pat. No. 6,232,870, and which therefore has the same disadvantages. The second solution consists of a mobile cart having a large panel for reading/querying the data media to scan the books on several parallel rows.

All the systems proposed in the prior art still have the disadvantage of not allowing security of reading/querying the data media. Specifically, the books, CD-ROMs or DVD-ROMs, items of jewelry disposed in rows, aligned on shelves, or for example on display in a jewelry store, rarely have equal dimensions and/or are not disposed at one and the same depth on the shelves, so the device for reading/querying the data media will not be presented at one and the same distance from said media, and in particular will sometimes be presented at a relatively long distance. Furthermore, in a store display case, the objects presented for sale are not usually aligned but simply disposed close to one another, without real arrangement. Thus, the greater the distance between the read/query device and the data medium, the greater the risk of not detecting the article. Furthermore, since the articles are disposed contiguous to one another, the read/query device will risk detecting the data medium of another article situated closer to said device, some articles then not being checked off or found.

### SUMMARY OF THE INVENTION

Naturally, thanks to the device according to the invention, it may also be possible to find or take stock of objects in a store, personal or business files at home or at one's place of work, even one's favorite kitchen spice stored in the kitchen.

The object of the invention is therefore to remedy the disadvantages of the prior art. For this purpose it proposes a device for identifying articles comprising a contactless label of the RFID type, the articles being aligned on a support, the device comprising at least one antenna, characterized in that said antenna is included in a flexible head suitable for deforming in contact with the contour of at least some of the articles aligned to present a zone in contact with said contour of the articles in contact, and a zone extending a manipulation medium.

In the following, the above-mentioned term “aligned”, with reference to the articles, means that said articles lie or are held on a support having a substantially flat surface, each article being placed contiguous to or at a distance from the others, for example placed on one of the small sides of a book or of a CD-ROM with the spine or the contour of said book or of said CD-ROM turned toward the exterior of the support.

Advantageously, the device according to the invention will comprise a means of connection with a power supply module of said antenna.

According to one embodiment of the invention, the connection means will consist of a wireless connection means.

According to another embodiment of the invention, the connection means will consist of a wired connection means, for example an electric cable.

According to a final embodiment of the invention, the device will comprise its own power supply module.

Advantageously, the device according to the invention will comprise a data storage means. In this case, the device may also comprise a comparison means for comparing the retrieved or collected items of data originating from a contactless label with an item of prerecorded data, corresponding to a particular label, in the data storage means.

The device may then comprise an input means for designating the book to be found and entering its identification in the aforementioned comparison means.

According to one possibility offered by the invention, the device will comprise an audible and/or visual signaling means, where necessary delivered via a user interface, signaling each retrieval of data or the retrieval of an item of data corresponding to a particular label.

Advantageously, the head will have a shape homothetic to the shape of the antenna, that is to say having dimensions at least greater than those of the antenna.

According to one possibility offered by the invention, the head will have a rectangular or ovoidal shape.

Preferably, the head will have a gripping means, such as a handle, allowing it to be transported and handled by an operator. The gripping means may comprise an activation trigger, or similar, used to activate/deactivate the aforementioned antenna.

According to one possibility offered by the invention, the aforementioned head will be connected to the handle via a swivel joint, or similar, capable of allowing said head to rotate on its axis and to have a freedom of angular movement of the order of ±20°.

Advantageously, the device according to the invention may be mounted on a movement means, such as a cart.

According to one aspect of the invention, the flexible head will be made of plastic.

According to one possibility offered by the invention, each label will comprise a data storage means, capable of recording a n-bit binary code; at least a portion of said memory being rewritable.

The invention also relates to a system for the identification of articles, characterized in that it comprises numerous contactless labels of the RFID type disposed on aligned articles and a device comprising an antenna, included in a flexible head capable of deforming in contact with the contour of at least some of the articles aligned to present a zone in contact with said contour of the articles in contact, and a zone extending a manipulation medium.

Thanks to these particular features, the invention can be used to detect and find in unfailing manner, and while minimizing the time spent by an operator, or several labels presented on articles disposed contiguously when the distances from said articles to the identification device is variable. Furthermore, the flexible antenna according to the invention causes less damage to the objects to be identified than a rigid antenna. Finally, because a reliable identification at a shorter distance can be achieved thanks to the device according to the invention, it is now possible to use RFID labels of small dimensions, to use a weaker reading power thus making it possible to produce lighter and more user-friendly “handheld” readers.

### BRIEF DESCRIPTION OF THE DRAWINGS

The invention will be better understood with the aid of the description, made hereinafter for purely explanatory reasons, of an embodiment of the invention, with reference to the appended figures:

FIG. 1 illustrates a schematic view of the flexible head according to the invention;

FIG. 2 illustrates a partial view in section of the flexible head carrying out a detection of contactless labels placed on the spine of numerous books, or of CD-ROMs/DVD-ROMs, disposed aligned with one another.

### DETAILED DESCRIPTION OF THE PREFERRED EMBODIMENT(S)

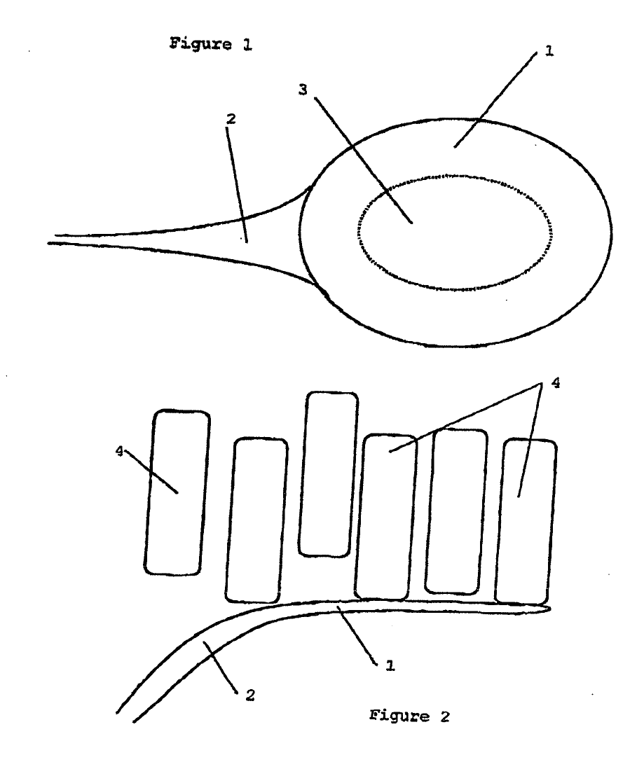

As can be seen in FIG. 1, the identification device according to the invention comprises a flexible head 1, made for example of relatively flexible plastic such as polyethylene (PE) or polypropylene (PP), the material of said head 1 being chosen in order to more easily and more durably insert a metal material forming an antenna 3. In the embodiment chosen to illustrate the invention, this flexible head 1 has an ovoidal shape and terminates at one of its ends in a gripping handle 2 allowing an operator/user to manipulate said head 1.

Naturally, this gripping handle 2 consists of a gripping means that may have various variable shapes, it being understood that its user-friendly shape must make it easy to be gripped by a human hand.

This flexible head, made of relatively flexible plastic, will comprise or support an antenna 3, said antenna delivering an electric signal to a receiving and modulating circuit present in the RFID label.

The flexible head may be used for writing data onto one or more labels, for example a change of classification of the article in question.

The word “antenna” will be understood to mean, in the meaning of the present application, a means sensitive to an electric or electromagnetic field and delivering an electromotive force that is a function of the electric or electromagnetic field detected by the antenna. The word “antenna” will include a means such as a loop in the case of a 13.56 MHz RFID label, a strand or any other appropriate element for generating an electric or electromagnetic field.

The word “antenna” will be understood to mean, in the meaning of the present patent application, a means sensitive to an electric or electromagnetic field and delivering an electromotive force that is a function of the electric or electromagnetic field detected by the antenna.

Thus, when the antenna 3 receives energy originating from a source of energy supply, not shown in the figures, and connected to said antenna 3 by a wired or wireless connection, the antenna creates a short distance electric or electromagnetic field. As previously specified, in the case in which the means of connection between the head 1 and the power supply means is of the wireless type, the connection means may be of the “Bluetooth”, “Airport” or “WIFI” type.

The device according to the invention may essentially be used in two nonlimiting cases described hereinafter.

The operator searches for a precise article 4, that is to say bearing a known identification number or code, for example stored in a server. In this case, the operator enters the identification number or code on an input means, for example a keyboard, in order to store it in a data storage means attached to the flexible head 1 or independent from the latter. The device will also comprise a comparison means suitable for making a comparison between the identification numbers or codes read off from each label and the identification number(s) or code(s) stored in the data storage means. If there is an effective match between the identification code of a label and the identification code stored, then a signaling means emits an audible or visual signal, for example a blinking light, indicating that the article sought has just been located.

The operator may also use the device of the invention to check off all the articles 4 present on a shelf. In this case, the user/operator similarly brings the flexible head 1 into contact with the articles 4, ideally close to the location of the RFID label present on or in the article 4, so that the head 1 bends and makes a flat surface contact with the contour of the article 4 to emit an electric or electromagnetic field substantially perpendicular to each label, the latter then being capable of being perfectly detected by the antenna 2.

In either case, the operator may use a handle comprising a trigger for activating/deactivating the aforementioned antenna 3. Naturally, provision may also be made for the case in which the antenna 3 is continuously active as soon as the operator has switched on the power supply means delivering energy to said antenna.

To carry out one or other of the tasks assigned to the device for identifying articles 4 comprising a contactless label, the user gently presses the flexible head 1 against the articles 4 to be monitored. Thus, the flexible head 1 is always at least partially in contact with the article 4 or close to this article 4, in the case for example in which the article 4 is significantly set back relative to its neighbors. The label of each article is therefore always within the electric or electromagnetic field of the antenna 2 and all the articles 4 may thus be identified.

The invention is described hereinabove as an example. It is understood that those skilled in the art are capable of producing different variants of the invention, particularly concerning the shape and dimensions of the various elements forming the device according to the invention, without, for all that, departing from the scope of the patent.

Thus, provision can be made for the head 1 to be connected to the gripping means by a swivel joint or a conical orifice capable of allowing said head 1 to rotate in relation to the axis of its handle 2 and to have a freedom of angular movement for example of the order of ±20°.

In the same manner, it can be envisaged to mount the flexible head 1 on a cart that can be moved by an operator or automatically, for example by remote control means, to facilitate the scanning of rows of articles 4 situated on shelves. In this case, it will be worthwhile to produce a flexible head 1 of large dimension so that it can be placed in contact with or close to articles 4 disposed on several levels, or heights, of shelves. Provision may also be made for this cart to comprise a user interface, of the display screen type, allowing the operator to view all the identification codes or numbers read off.

The flexible head according to the invention may have numerous fingers, for example like tentacles. In this case, provision can be made for each of the fingers or tentacles to comprise at least one antenna, this particular geometry can be used to scan a wider area of inspection.

Furthermore, the antenna or antennae used in the flexible head according to the invention may consist of three-dimensional antennae or flat antennae.

The handle, connected to the flexible head and allowing the device to be gripped, may also comprise a telescopic tube capable of increasing or reducing the distance between the handle and the flexible head so that a user may without difficulty bring the flexible head close to articles further away.

1-23. (canceled)

24. A device for identifying articles comprising a contactless label of the RFID type, the articles being aligned on a support, the device comprising at least one antenna, said at least one antenna being included in a flexible head suitable for deforming in contact with a contour of at least some of the articles aligned to present a zone in contact with said contour of the articles in contact, and a zone extending a manipulation medium.

25. The device as claimed in claim 24, further comprising a means of connection with a power supply module of said at least one antenna.

26. The device as claimed in claim 25, wherein the connection means consists of a wireless connection means.

27. The device as claimed in claim 25, wherein the connection means consists of a wired connection means.

28. The device as claimed in claim 24, further comprising a power supply module.

29. The device as claimed in claim 24, further comprising a data storage means.

30. The device as claimed in claim 29, further comprising a comparison means for comparing retrieved or collected items of data originating from a contactless label with an item of prerecorded data, corresponding to a particular label, in the data storage means.

31. The device as claimed in claim 30, further comprising an audible and/or visual signaling means, where necessary delivered via a user interface, signaling each retrieval of data or the retrieval of an item of data corresponding to a particular label.

32. The device as claimed in claim 30, further comprising an input means for designating a book to be found and entering its identification in the comparing means.

33. The device as claimed in claim 24, wherein the head has a shape homothetic to the shape of the at least one antenna, that is to say having dimensions at least greater than those of the at least one antenna.

34. The device as claimed in claim 24, wherein the head has a rectangular or ovoidal shape.

35. The device as claimed in claim 24, wherein the head has a gripping means for allowing the head to be transported and handled by an operator.

36. The device as claimed in claim 35, wherein the head is connected to the gripping means via a joint means for allowing said head to rotate on its axis and to have a freedom of angular movement of the order of ±20°.

37. The device as claimed in claim 24, further comprising said device being mounted on a movement means.

38. The device as claimed in claim 35, wherein the gripping means comprises an activation trigger means for activating/deactivating the at least one antenna.

39. The device as claimed in claim 24, wherein the flexible head is made of plastic.

40. The device as claimed in claim 24, wherein each label comprises a data storage means, capable of recording a n-bit binary code; and at least a portion of said data storage means being rewritable.

41. The device as claimed in claim 24, further comprising a user interface making it possible to display the items of data originating from the contactless label.

42. The device as claimed in claim 24, wherein the flexible head has numerous fingers.

43. The device as claimed in claim 42, wherein each of the fingers comprises at least one antenna.

44. The device as claimed in claim 24, wherein the at least one antenna in the flexible head consists of a three-dimensional antenna or a flat antenna.

45. The device as claimed in claim 24, further comprising the gripping means comprising a telescopic tube capable of increasing or reducing the distance between said gripping means and the flexible head.

46. A system for the identification of articles comprising numerous contactless labels of the RFID type disposed on aligned articles and a device comprising an antenna, included in a flexible head capable of deforming in contact with a contour of at least some of the articles aligned to present a zone in contact with the contour of the articles in contact, and a zone extending a manipulation medium.
